(19) United States
(12) Patent Application Publication
(10) Pub. No.: US 2013/0115819 A1
(43) Pub. Date: May 9, 2013

(54) ADAPTER CARD FOR PCI EXPRESS X1 TO COMPACT PCI EXPRESS X1

(71) Applicants: Cong Liu, Beijing (CN); Qiang Zhou, Beijing (CN); Long Qu, Beijing (CN); Zhiyue Xu, Beijing (CN); Yabin Liu, Beijing (CN)

(72) Inventors: Cong Liu, Beijing (CN); Qiang Zhou, Beijing (CN); Long Qu, Beijing (CN); Zhiyue Xu, Beijing (CN); Yabin Liu, Beijing (CN)

(73) Assignee: BEIHANG UNIVERSITY, Beijing (CN)

(21) Appl. No.: 13/519,103

(22) PCT Filed: Sep. 26, 2010
(86) PCT No.: PCT/CN10/01491

§ 371 Date: Jun. 25, 2012

(30) Foreign Application Priority Data
Aug. 17, 2010 (CN) 201010256360

(51) Int. Cl. H01R 31/06

(52) U.S. Cl. CPC H01R 31/06
USPC 439/628

(57) ABSTRACT

An adapter card is used to convert the PCI Express X1 slot to CompactPCI Express X1 slot which is compatible with PICMG EXP.0 R1.0 specification in the commercial and industrial control computer. The adapter card includes the impedance controlled circuit board, the connecting circuit board, the PCI Express port, the CPCI Express signal socket, the CPCI power socket, the double row hole socket, the double row bent needle plug, the linking block and a dam-board. The adapter card expands the application of PCI Express X1 slots by a large margin and make it compatible with CPCI Express X1 card.

### FIELD OF THE INVENTION

This invention generally relates to an adapter card for PCI Express X1 to Compact PCI Express X1. The adapter card is used to convert the PCI Express X1 slot to CompactPCI Express X1 slot which is compatible with PICMG EXP.0 R1.0 specification in computers. It can make Compact PCI Express X1 card compatible with PICMG EXP.0 R1.0 specification for application, debug and testing in the PCI Express X1 slot. This invention belongs to the technical field of computer communication, computer aided testing and automation testing.

### BACKGROUND OF INVENTION

PCI Express is the new generation of serial bus of computer whose protocol replaces the traditional synchronous or asynchronous logic bus interface with the highlighted characteristics of high transmission rate, less hardware resource needed, no crosstalk, no clock jitter, no signal skew and no direct current bias, etc. Currently, PCI Express expansion slots are used in all commercial and industrial computers and gradually replaces legacy PCI bus.

PCI Express bus can be configured from 1 lane to 32 lanes with high flexibility to meet the requirements for facilities with different data transmission bandwidth. The commonly used configurations of Express bus include X1, X4, X8 and X16. PCI Express cards with fewer lanes can be inserted into PCI Express slots with more lanes, the so called “up-plugging”. The boundary dimension and connection format of PCI Express expansion card are similar to PCI bus. However, it has completely different pin definitions.

CompactPCI Express is a compact express specification which was released by International Industrial Computer Manufacturer's Group, PICMG, in 2005 after CompactPCI (Compact Peripheral Component Interconnect).

CompactPCI Express maintains the technological advantages of CompactPCI, including high reliability structure of European card, ameliorated radiating condition, improved vibration- and impact-resistance, electromagnetic compatibility and 2-mm density high-speed perforation connector to replace the golden finger of PCI Express with higher reliability, integrity of high speed differential signal and improved load capacity. More importantly, CompactPCI Express transmits mostly high-speed and low swing differential signals which is compatible with all interface protocols of PCI Express bus. CompactPCI Express has very broad applications in telecom, computer communication, industrial control and test, aerospace, etc. due to its irreplaceable advantages

However, the characteristics of CompactPCI Express card and chassis make the arrangements of CompactPCI Express card in the chassis very compact and it is almost not convenient to finish the related developing, testing and debugging. Meanwhile, the related devices is very expensive and the set-up of CompactPCI Express basic platform is costly.

A low cost environment, compatible with interface protocol for CompactPCI Express card and convenient for developing, testing and debugging, is highly desirable. The interface protocol of PCI Express and CompactPCI Express is identical with much internal relevance. PCI Express is the platform with high popularity, low cost and flexibility for developing, testing and debugging for both commercial and industrial systems. However, the obvious differences in the connector and port definition of CompactPCI Express and PCI Express specification makes it impossible for CompactPCI Express card for applications, debugging and testing in PCI Express system which means PCI Express system is currently not compatible with CompactPCI Express card.

### SUMMARY OF THE INVENTION

The object of the present invention is to provide an adapter card for PCI Express X1 to Compact PCI Express X1. The adapter card is used to convert the PCI Express X1 slot to CompactPCI Express X1 slot which is compatible with PICMG EXP.0 R1.0 specification in the commercial and industrial control computer. It can make CompactPCI Express X1 card compatible with PICMG EXP.0 R1.0 specification used for application, debugging and testing in the PCI Express X1 slot of commonly used commercial and industrial control computers.

The transitions in the present invention comprises converting PCI Express X1 physics slot to CPCI Express X1 signal slot XP3 and auxiliary power slot XP4 respectively; transferring reference differential clock signals (RefClk+ and RefClk−), receiving differential signals (PERp0 and PERn0), transmitting differential signals (PETp0 and PETn0) and reference ground signals using impedance controlled circuit board; transferring +12V and +3.3V direct current power supply using impedance controlled circuit board.

An adapter card for PCI Express X1 to Compact PCI Express X1 comprises:

An impedance controlled circuit board: it can transmit low voltage differential signals to the CPCI Express signal socket XP3 with high-speed, low loss and short distance.

A connecting circuit board: it is vertically installed on the upper edge of the impedance controlled circuit board by the linking block.

A PCI Express port: it is on the bottom edge of the impedance controlled circuit board, interfaces physically to PCI Express X1 slot and transfers signals and power.

A CPCI Express signal socket: it is installed on the upper edge of the impedance controlled circuit board, interfaces physically to the signal connector XP3 in CPCI Express X1 and transfers signals.

A CPCI power socket: it is installed on the connecting circuit board, interfaces physically to the power connector XP4 in CPCI Express X1 and transfers power.

A double row hole socket: it is installed on the upper edge of the impedance controlled circuit board and is used to transfers power.

A double row bent needle plug: it is installed on the connecting circuit board and is used to connect to the double row hole socket and transfers power.

A linking block: it uses screws to connect the impedance controlled circuit board with the connecting circuit board vertically.

A dam-board: one side of the dam-board connects with the impedance controlled circuit board, and the other side connects with the edge of computer chassis by screw.

Wherein, the impedance controlled circuit board is a multilevel circuit board which has 4 layers at least.

Wherein, the impedance controlled circuit board has 2 reference ground layers and 2 signal layers at least.

Wherein, the thickness of the impedance controlled circuit board is 63 mil (1.6 mm) or above.

Wherein, the contour of the impedance controlled circuit board is L shape.

Wherein, the differential characteristic impedance of differential signal lines in the impedance controlled circuit board is 100 Ohm±10 Ohm.

Wherein, the single-ended characteristic impedance of signal lines referred to reference ground in the impedance controlled circuit board is 50 Ohm±10 Ohm.

Wherein, the length of differential signal lines in the impedance controlled circuit board is smaller than 1000 mil (25.4 mm).

Wherein, the length difference of two signal lines which belong to a pair of differential signal lines in the impedance controlled circuit board is smaller than 5 mil (0.127 mm).

Wherein, the PCI Express port which is compatible with PCI Express Card Electromechanical Specification Revision 1.0 is PCI Express X1 golden finger port.

Wherein, the double row hole socket transfers +12 voltage and +3.3 voltage direct-current power supply.

Wherein, the CPCI Express signal socket transfers the reference differential clock signals (RefClk+ and RefClk−), receiving differential signals (PERp0 and PERn0), transmitting differential signals (PETp0 and PETn0) and reference ground signal at least.

The present invention relates to an adapter card for PCI Express X1 to Compact PCI Express X1. The advantages and virtues of the present invention are high-speed transmission for low voltage differential signals, low power consumption and short distance by multilevel impedance controlled circuit board without affecting the quality and efficiency if the precision of the impedance control meets requirements. Simultaneously, the present invention can expand the application of PCI Express X1 slots by a large margin and make it compatible with CPCI Express X1 card. The present invention reduces the difficulty and cost of developing the CPCI Express X1 card sharply and improves the testability and debugging ability of the CPCI Express X1 card. Finally, the structure of the present invention is simple and easy to use.

### BRIEF DESCRIPTION OF THE DRAWINGS

FIG. 1A is the axis side view of the present invention.

FIG. 1B is the backward axis side view of the present invention.

FIG. 2 is the dimension figure of the impedance controlled circuit board 101 in FIG. 1A.

FIG. 3 is the dimension figure of the connecting circuit board 105 in FIG. 1A.

FIG. 4A is the PCB design view of the first layer in the impedance controlled circuit board 101 of FIG. 1A.

FIG. 4B is the PCB design view of the fourth layer in the impedance controlled circuit board 101 of FIG. 1A.

FIG. 5A is the PCB design view of the first layer in the connecting circuit board 105 of FIG. 1A.

FIG. 5B is the PCB design view of the second layer in the connecting circuit board 105 of FIG. 1A.

FIG. 6 is the layer design view of the impedance controlled circuit board 101 in FIG. 1A.

FIG. 7 is the layer design view of the connecting circuit board 105 in FIG. 1A.

FIGURE LEGENDS

| | |
|---|---|
| 101. impedance controlled circuit | 102. PCI Express X1 port |
| board | |
| 103. CPCI Express signal socket | 104. CPCI Express power socket |
| 105. connecting circuit board | 106. dam-board |
| 107. double row hole socket | 108. double row bent needle plug |
| 109. linking block | 110. M3 screw |
| 111. M2 screw | 401. +3.3 voltage direct current |
| | power copper plane |
| 402. WAKE# signal routing | 403. differential reference clock |
| | routing |
| 404. PCI Express reset signal | 405. system management bus routing |
| routing | |
| 406. PCI Express transmitting | |
| differential signals routing | |
| 407. +12 voltage direct current | |
| power copper plane | |
| 408. PCI Express receiving | |
| differential signals routing | |
| 409. hot-plug presence detect | |
| signal routing | |
| 410. M3 screw hole | 411. M2 screw hole |
| 412. PCI Express X1 golden finger | 413. CPCI Express signal socket hole |
| 414. 10 needle double row hole | 501. +12 voltage direct current power |
| | copper plane |
| 502. +3.3 voltage direct current | |
| power copper plane | |
| 503. GND copper plane | 504. WAKE# signal routing |
| 505. CPCI Express power socket | 506. M2 screw hole |
| hole | |
| 507. 10 needle double row hole | |

The present invention refers to the units below:

Ω ohm
mm millimeter
mil milli-inch

### DETAILED DESCRIPTION OF EMBODIMENT

The detailed embodiment of the invented device is listed below with referring to the attached Figures.

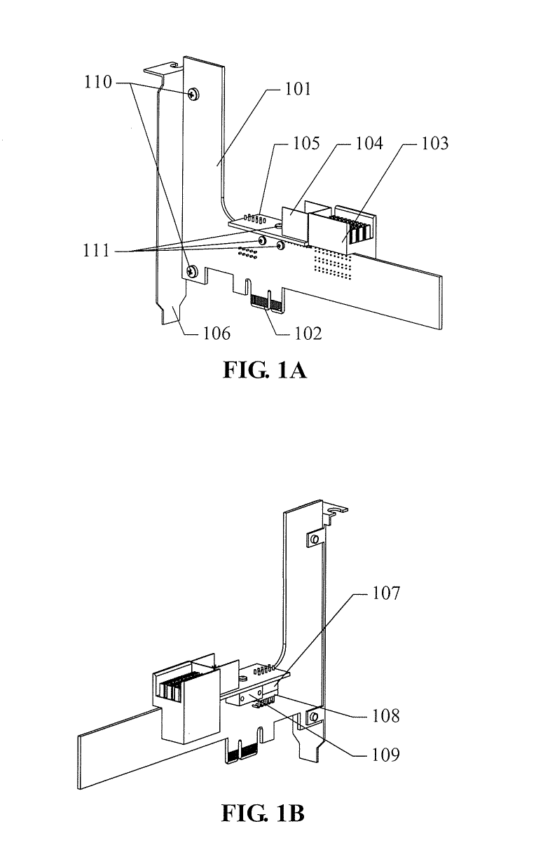

Refer to FIG. 1A, the present invention is an adapter card for PCI Express X1 to Compact PCI Express X1 which comprises one impedance controlled circuit board 101, one connecting circuit board 105, one CPCI Express power socket 104, one CPCI Express signal socket 103, one double row hole socket 107, one double row bent needle plug 108, one linking block 109, one dam-board 106, three M2 screws 111 and three M3 screws 110.

PCI Express X1 port 102 is arranged on the bottom edge of the impedance controlled circuit board 101. It is used to interface physically to the PCI Express X1 slot and transfer signals and power.

Wherein, the golden fingers which are the form of PCI Express port are arranged on the bottom edge of the impedance controlled circuit board 101.

Please refer to TAB. 1, the golden finger pins and their signal definitions of PCI Express port 102 are listed below which is compatible with PCI Express Card Electromechanical Specification Revision 2.0.

TABLE 1

| | B Side | | A Side | |
|---|---|---|---|---|
| Pin # | Name | Description | Name | Description |
| 1 | +12 V | +12 V Power | PRSNT1# | hot-plug existing detection signal |
| 2 | +12 V | +12 V Power | +12 V | +12 V Power |
| 3 | +12 V | +12 V Power | +12 V | +12 V Power |
| 4 | GND | reference ground | GND | reference ground |
| 5 | SMCLK | SMBUS(system management bus) clock | JTAG2 | TCK(testing clock): the clock of |
| | | | | inputting the JTAG port |
| 6 | SMDAT | SMBUS(system management bus) data | JTAG3 | TDI(testing data input) |
| 7 | GND | reference ground | JTAG4 | TDO(testing data input) |
| 8 | +3.3 V | +3.3 V Power | JTAG5 | TMS(testing mode select) |
| 9 | JTAG1 | TRST#(test reset) reset JTAG port | +3.3 V | +3.3 V Power |
| 10 | 3.3Vaux | 3.3 V auxiliary power | +3.3 V | +3.3 V Power |
| 11 | WAKE# | link activation signal | PERST# | fundamental reset |

mechanical key

| | | | | |
|---|---|---|---|---|
| 12 | RSVD | Reserved | GND | reference ground |
| 13 | GND | reference ground | REFCLK+ | reference clock(difference line pair) |
| 14 | PETp0 | transmitter difference line pair, lane0 | REFCLK− | |
| 15 | PETn0 | | GND | reference ground |
| 16 | GND | reference ground | PERp0 | receiver difference line pair, lane 0 |
| 17 | PRSNT1# | hot-plug presence detect | PERn0 | |
| 18 | GND | reference ground | GND | reference ground |

CPCI Express signal socket 103 is on the upper edge of the impedance controlled circuit board 101 and used to interface physically to the signal connector XP3 in CPCI Express X1 and transfers signals.

Please refer to TAB. 2, the pins and their signal definitions of CPCI Express signal socket 103 are listed below which is compatible with PXI Express Hardware Specification Revision 1.0.

TABLE 2

| Pin # | Z | A | B | C | D | E | F | |
|---|---|---|---|---|---|---|---|---|
| 1 | GND | GA4 | GA3 | GA2 | GA1 | GA0 | GND | XP4 |
| 2 | GND | 5Vaux | GND | SYSEN# | WAKE# | ALERT# | GND | plug/ |
| 3 | GND | 12 V | 12 V | GND | GND | GND | GND | socket |
| 4 | GND | GND | GND | 3.3 V | 3.3 V | 3.3 V | GND | |
| 5 | GND | PXI_TRIG3 | PXI_TRIG4 | PXI_TRIG5 | GND | PXI_TRIG6 | GND | |
| 6 | GND | PXI_TRIG2 | GND | ATNLED | PXI_STAR | PXI_CLK10 | GND | |
| 7 | GND | PXI_TRIG1 | PXI_TRIG0 | ATNSW# | GND | PXI_TRIG7 | GND | |
| 8 | GND | RSV | GND | RSV | PXI_LBL6 | PXI_LBR6 | GND | |

| Pin # | A | B | ab | C | D | cd | E | F | ef | |
|---|---|---|---|---|---|---|---|---|---|---|
| 1 | PXIe_{—} | PXIe_{—} | GND | PXIe_{—} | PXIe_{—} | GND | PXIe_{—} | PXIe_{—} | GND | XP3 |
| | CLK100+ | CLK100− | | SYNC100+ | SYNC100− | | DSTARC+ | DSTARC− | | plug/ |
| 2 | PRSNT# | PWREN# | GND | PXIe_{—} | PXIe_{—} | GND | PXIe_{—} | PXIe_{—} | GND | socket |
| | | | | DSTARB+ | DSTARB− | | DSTARA+ | DSTARA− | | |
| 3 | SMBDAT | SMBCLK | GND | RSV | RSV | GND | RSV | RSV | GND | |
| 4 | MPWRGD | PERST# | GND | RSV | RSV | GND | 1RefClk+ | 1RefClk− | GND | |
| 5 | 1PETp0 | 1PETn0 | GND | 1PERp0 | 1PERn0 | GND | 1PETp1 | 1PETn1 | GND | |
| 6 | 1PETp2 | 1PETn2 | GND | 1PERp2 | 1PERn2 | GND | 1PERp1 | 1PERn1 | GND | |
| 7 | 1PETp3 | 1PETn3 | GND | 1PERp3 | 1PERn3 | GND | 1PETp4 | 1PETn4 | GND | |
| 8 | 1PETp5 | 1PETn5 | GND | 1PERp5 | 1PERn5 | GND | 1PERp4 | 1PERn4 | GND | |
| 9 | 1PETp6 | 1PETn6 | GND | 1PERp6 | 1PERn6 | GND | 1PETp7 | 1PETn7 | GND | |
| 10 | RSV | RSV | GND | RSV | RSV | GND | 1PERp7 | 1PERn7 | GND | |

The double row bent needle plug 108 is arranged on the left upper center of the impedance controlled circuit board 101 and used to interface physically to the double row hole socket 107 and transfer direct current power from the impedance controlled circuit board 101 to the connecting circuit board 105.

The connecting circuit board 105 is fixed horizontally on the upper edge of the impedance controlled circuit board 101 and used to transfer direct current power from the double row hole socket 107 to the CPCI Express power socket 104.

The CPCI Express power socket 104 is used to interface physically to the power connector XP4 in CPCI Express X1 and transfer direct current power.

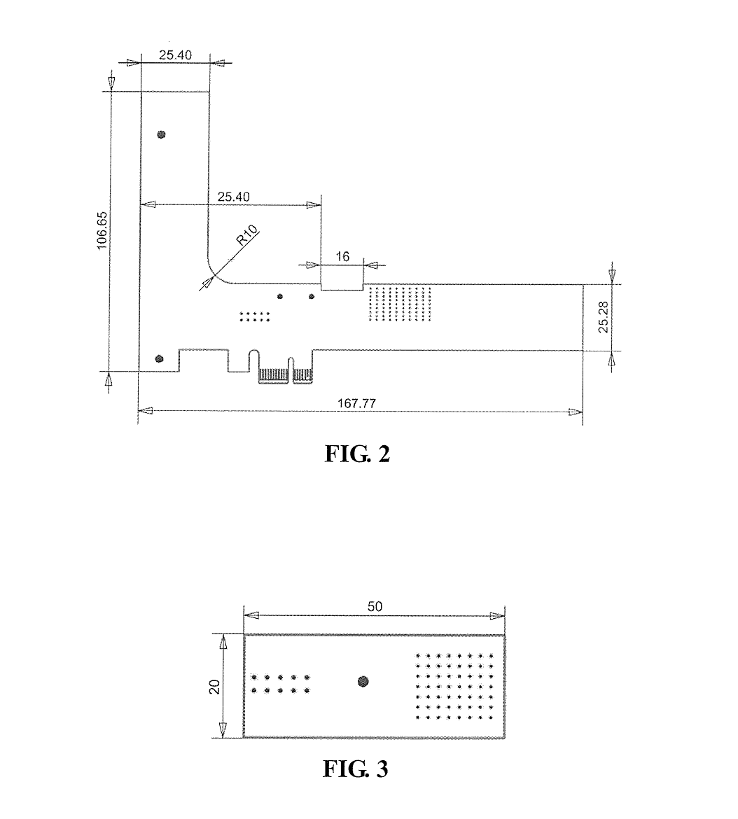

Please refer to FIG. 2, the shape of the impedance controlled circuit board 101 is L. And its thickness is 63 mil (1.6 mm) or above. About the dimension of the impedance controlled circuit board 101, please refer to FIG. 2 and the unit is mm.

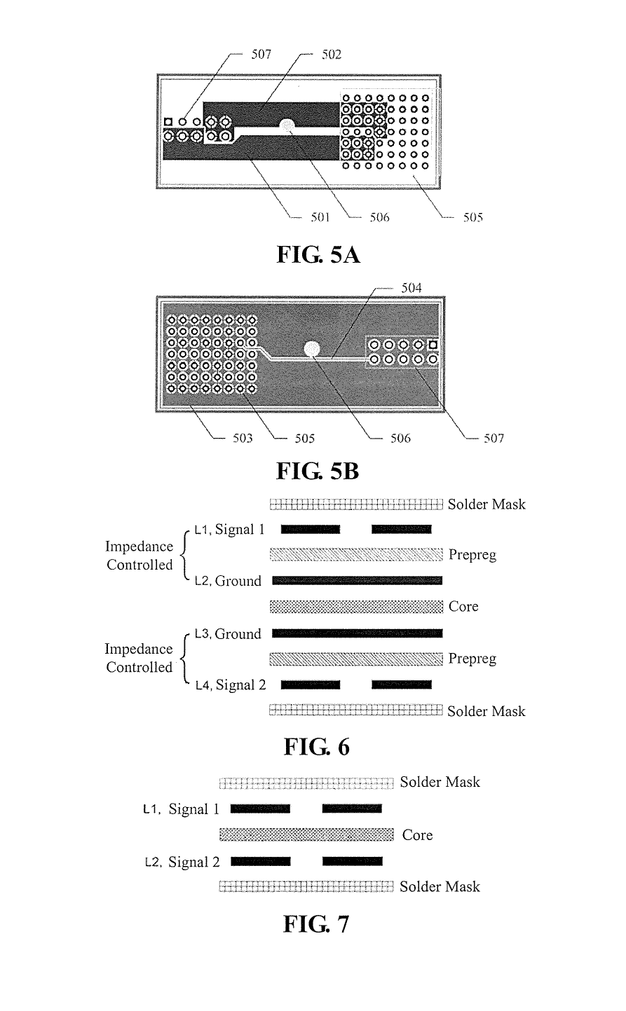

Please refer to FIG. 6, the impedance controlled circuit board 101 is four-layer circuit board.

Wherein, the first layer L1 of the impedance controlled circuit board 101 is the signal layer 1. And the second layer L2 and the third layer L3 are the ground layers. At last, the fourth layer L4 is the signal layer 2. The thickness of every layer is listed in TAB. 3.

TABLE 3

| Layer | Style | Thickness (mils) |
|---|---|---|
| L1 | | 0.60 |
| | Prepreg | 4.00 |
| L2 | | 1.20 |
| | Core board | 51.4 |
| L3 | | 1.20 |
| | Prepreg | 4.00 |
| L4 | | 0.60 |

Wherein, the single-ended characteristic impedance of all signal lines which belong to the signal layer 1 and 2 of the impedance controlled circuit board 101 is 50Ω±10Ω. And the differential characteristic impedance of differential signal lines is 100Ω±10Ω.

On the impedance controlled circuit board 101, the width of the differential signal line is 5 mil. And the separation between two signal lines that belongs to a pair of differential signal line is 7 mil. Meanwhile, the distance of different pairs of differential signal lines is greater than 20 mil. This is the way to control the signal characteristic impedance of the impedance controlled circuit board 101. With the simulation calculation, the differential characteristic impedance of the differential signal line is 101.8Ω and the single-ended characteristic impedance of the differential signal line is 51.78Ω.

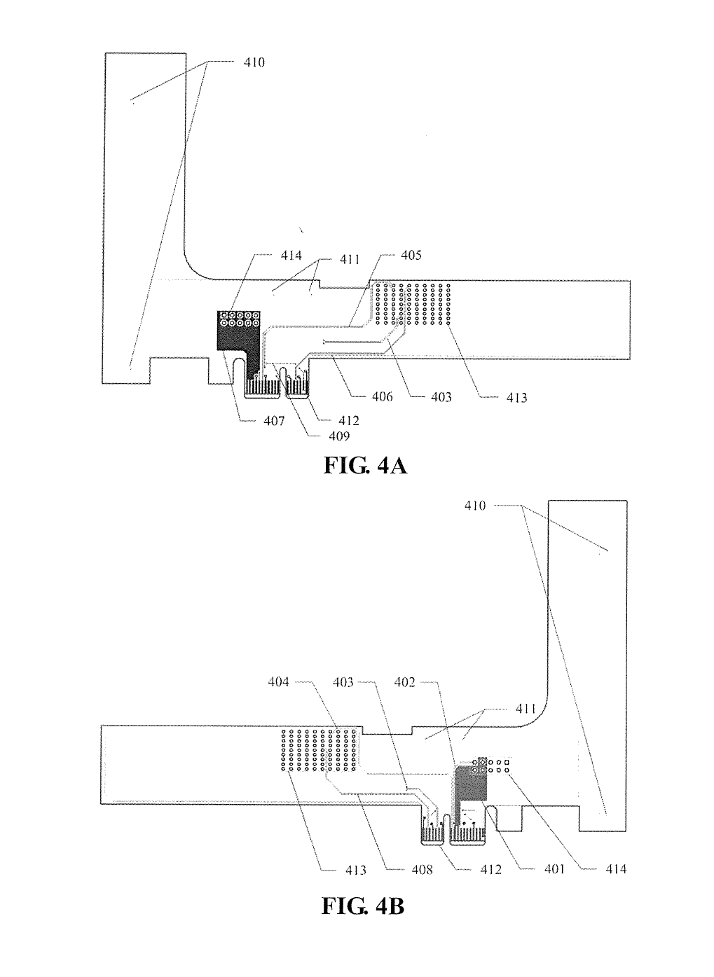

Refer to FIG. 4A, the first layer of the impedance controlled circuit board 101 has the system management bus routing 405, the differential reference clock signal routing 403, the PCI Express transmitting differential signals routing 406, the hot-plug presence detect signal routing 409 and +12V direct current power copper plane 407.

The system management bus routing 405 comprises SMBUS clock signal (SMCLK) and SMBUS data signal (SMDAT).

Wherein, the SMCLK signal links the golden finger pin B5 of PCI Express X1 port 102 with the pin B3 of CPCI Express signal socket 103.

Wherein, the SMDAT signal links the golden finger pin B6 of PCI Express X1 port 102 with the pin A3 of CPCI Express signal socket 103.

The differential reference clock routing 403 comprises one pair of differential reference clock: REFCLK+ and REFCLK−.

Wherein, the REFCLK+ signal links the golden finger pin A13 of PCI Express X1 port 102 with the pin E4 of CPCI Express signal socket 103.

Wherein, the REFCLK+ signal links the golden finger pin A14 of PCI Express X1 port 102 with the pin F4 of CPCI Express signal socket 103.

The PCI Express transmitting differential signals routing 406 comprises PCI Express Transmitter Positive Lane 0 (PETp0) signal and PCI Express Transmitter Negative Lane 0 (PETn0) signal.

Wherein, the PETp0 signal links the golden finger pin B14 of PCI Express X1 port 102 with the pin A5 of CPCI Express signal socket 103.

Wherein, the PETn0 signal links the golden finger pin B15 of PCI Express X1 port 102 with the pin B5 of CPCI Express signal socket 103.

The hot-plug presence detect signal routing 409 comprises PRSNT1# signal and PRSNT2# signal.

Wherein, the golden finger pin A1 (PRSNT1#) and B17 (PRSNT2#) of PCI Express X1 port 102 are linked by the hot-plug presence detect signal routing 409.

+12V direct current power copper plane 407 transmits +12V direct current power from the golden finger pin B1 and B2 of PCI Express X1 port 102 to the double row bent needle plug 108.

Refer to FIG. 4B, the fourth layer of the impedance controlled circuit board 101 has the WAKE# signal routing 402, the differential reference clock signal routing 403, the PCI Express receiving differential signals routing 408, the PCI Express reset signal routing 404 and +3.3V direct current power copper plane 401.

The WAKE# signal 402 links the golden finger pin B11 of PCI Express X1 port 102 with the double row bent needle plug 108.

The differential reference clock signal routing 403 comprises one pair of differential reference clock: REFCLK+ signal and REFCLK− signal.

Wherein, the REFCLK+ signal links the golden finger pin A13 of PCI Express X1 port 102 with the pin E4 of CPCI Express signal socket 103.

Wherein, the REFCLK+ signal links the golden finger pin A14 of PCI Express X1 port 102 with the pin F4 of CPCI Express signal socket 103.

The PCI Express receiving differential signals routing 408 includes PCI Express Receiver Positive Lane 0 (PERp0) signal and PCI Express Receiver Negative Lane 0 (PERn0) signal.

Wherein, the PERp0 signal links the golden finger pin B14 of PCI Express X1 port 102 with the pin A5 of CPCI Express signal socket 103.

Wherein, the PERn0 signal links the golden finger pin B15 of PCI Express X1 port 102 with the pin B5 of CPCI Express signal socket 103.

The PCI Express reset signal routing 404 comprises PERST# signal.

Wherein, the PERST# signal links the golden finger pin A11 of PCI Express X1 port 102 with the pin B4 of CPCI Express signal socket 103.

+3.3V direct current power copper plane 401 transmits +3.3V direct current power from the golden finger pin A9 and A10 of PCI Express X1 port 102 to the double row bent needle plug 108.

Refer to FIG. 3, the shape of the connecting circuit board 105 is the rectangle. And its thickness is 63 mil (1.6 mm) or above. About the dimension, please refer to FIG. 3 and the unit is mm.

Refer to FIG. 7, the connecting circuit board 105 is two-layer circuit board.

Wherein, the first layer L1 of the connecting circuit board 105 is the signal layer 1. And the second layer L2 is the signal layer 2. The thickness of every layer is listed in TAB. 4.

TABLE 4

| Layer | Style | Thickness (mils) |
|---|---|---|
| L1 | | 0.60 |
| | Core board | 61.8 |
| L2 | | 0.60 |

Refer to FIG. 5A, the first layer of the connecting circuit board 105 has +12V direct current power copper plane 501 and +3.3V direct current power copper plane 502.

+12V direct current power copper plane 501 transmits +12V direct current power from the double row hole socket 107 to the pin A3 and B3 of CPCI Express power socket 104.

+3.3V direct current power copper plane 501 transmits +3.3V direct current power from the double row hole socket 107 to the pin C4, D4 and E3 of CPCI Express power socket 104.

Refer to FIG. 5B, the second layer of the connecting circuit board 105 has ground copper plane 503 and WAKE# signal routing 504.

The WAKE# signal 504 links the double row hole socket 107 with the pin D2 of CPCI power socket 104.

Refer to FIG. 1, the installation steps of the adapter card for PCI Express X1 to Compact PCI Express X1 is listed below:

Weld the CPCI Express signal socket 103 and double row bent needle plug 108 to the impedance controlled circuit board 101.

Weld the CPCI power socket 104 and double row hole socket 107 to the connecting circuit board 105.

Refer to FIG. 1A and FIG. 1B and fix horizontally the connecting circuit board 105 on the upper edge of the impedance controlled circuit board 101. And connect physical the double row bent needle plug 108 with the double row hole socket 107.

Connect the connecting circuit board 105 with the impedance controlled circuit board 101 using the linking block 109 and M2 screw 111.

Connect the impedance controlled circuit board 101 with the dam-board 106 using the M3 screw 110.

1. An adapter card for PCI Express X1 to Compact PCI Express X1 comprising:
an impedance controlled circuit board that transmits low voltage differential signals of a PCI Express X1 slot to the CPCI Express signal socket;
a connecting circuit board vertically installed on an upper edge of the impedance controlled circuit board;
a PCI Express port on a bottom edge of the impedance controlled circuit board, physically interfacing to the PCI Express X1 slot configured to transfer signals and power;
a CPCI Express signal socket installed on the upper edge of the impedance controlled circuit board, physically interfacing to a signal connector XP3 in the CPCI Express X1 and configured to transfer signals;
a CPCI power socket installed on the connecting circuit board, physically interfacing to a power connector XP4 in the CPCI Express X1 and configured to transfer power;
a double row hole socket installed on the upper edge of the impedance controlled circuit board configured to transfer power;
a double row bent needle plug installed on the connecting circuit board and is used to connect to the double row hole socket configured to transfer power;
a linking block releasably connecting the impedance controlled circuit board with the connecting circuit board vertically; and
a dam-board having one side connected with the impedance controlled circuit board, and another side connected with the edge of computer chassis.

2. The adapter card for PCI Express X1 to Compact PCI Express X1 of claim 1, wherein the impedance controlled circuit board has more than 4 layers.

3. The adapter card for PCI Express X1 to Compact PCI Express X1 of claim 1, wherein the impedance controlled circuit board has two reference ground layers and two signal layers at least.

4. The adapter card for PCI Express X1 to Compact PCI Express X1 of claim 1, wherein the thickness of the impedance controlled circuit board is 63 mil (1.6 mm) or above.

5. The adapter card for PCI Express X1 to Compact PCI Express X1 of claim 1, wherein the shape of the impedance controlled circuit board is L shape.

6. The adapter card for PCI Express X1 to Compact PCI Express X1 of claim 1, wherein the differential characteristic impedance of differential signal lines in the impedance controlled circuit board is 100Ω±10Ω.

7. The adapter card for PCI Express X1 to Compact PCI Express X1 of claim 1, wherein the single-ended characteristic impedance of signal lines referred to reference ground in the impedance controlled circuit board is 50 Ohm±10 Ohm.

8. The adapter card for PCI Express X1 to Compact PCI Express X1 of claim 1, wherein the length of the difference signal lines in the impedance controlled circuit board is smaller than 1000 mil (25.4 mm).

9. The adapter card for PCI Express X1 to Compact PCI Express X1 of claim 1, wherein the length difference of two signal lines which belong to a pair of differential signal lines in the impedance controlled circuit board is smaller than 5 mil (0.127 mm).

10. The adapter card for PCI Express X1 to Compact PCI Express X1 of claim 1, wherein the PCI Express port which is compatible with PCI Express Card Electromechanical Specification Revision 1.0 is PCI Express X1 golden finger port.

11. The adapter card for PCI Express X1 to Compact PCI Express X1 of claim 1, wherein the double row hole socket transfers +12 voltage and +3.3 voltage direct-current power supply.

12. The adapter card for PCI Express X1 to Compact PCI Express X1 of claim 1, wherein the CPCI Express signal socket transfers the reference differential clock signals (RefClk+ and RefClk−), receiving differential signals (PERp0 and PERn0), transmitting differential signals (PETp0 and PETn0) and reference ground signal.
